(19) United States
(12) Patent Application Publication
(10) Pub. No.: US 2026/0212262 A1
(43) Pub. Date: Jul. 23, 2026

(54) TRAINING DATA MANAGEMENT SYSTEM

(71) Applicant: ASTEMO, LTD., Tokyo (JP)

(72) Inventors: Masafumi TSUYUKI, Tokyo (JP); Trongmun JIRALERSPONG, Hitachinaka-shi (JP)

(73) Assignee: Astemo, Ltd., Tokyo (JP)

(21) Appl. No.: 19/141,192

(22) PCT Filed: Aug. 25, 2023
(86) PCT No.: PCT/JP2023/030754

§ 371 Date: Jun. 19, 2025

(30) Foreign Application Priority Data
Jan. 5, 2023 (JP) 2023-000382

(51) Int. Cl. G06N 20/00

(52) U.S. Cl. CPC G06N 20/00

(57) ABSTRACT

A training data management system according to the invention includes: a test data management unit configured to manage test data to which a label is to be assigned; a classification model selection unit configured to select a classification model for selecting the label; a classification unit configured to calculate a confidence factor indicating necessity to correct the label selected by the classification model; and a correction candidate calculation unit configured to recommend a correction candidate of the label when the confidence factor exceeds a predetermined value.

### TECHNICAL FIELD

The present invention relates to a system for managing training data used when assigning a label to a defect that occurs in an industrial product or the like.

### BACKGROUND ART

A task of reading a document described in a natural language and classifying inquiry contents described in the document is a task that frequently occurs in operations of a call center and customer support. When classification of a large number of documents is requested daily, it takes time to manually perform this classification task. As a method of saving labor for such work, there is a method of constructing a document classification model by supervised learning, which is a type of machine learning, and automatically solving a classification task.

Specifically, for example, the following is performed. First, training data including a large number of pairs of dependent variables and independent variables is created. In a classification task, this dependent variable is also referred to as a ground truth label. In the above-described document classification work, examples of the ground truth label for the training data include categories indicating contents described in the document, such as “request” and “guarantee application”. Examples of the independent variable include a text written in a document such as “please make operation method easier to understand” or “please exchange because it is damaged at time of opening”, and supplementary information such as a time when the document is written and a person who writes the document. Next, in order to make the training data into a format that is easy to machine process, a ground truth label is encoded as a scalar value, an independent variable is encoded as a multidimensional feature vector, which are then input into a machine learning algorithm, such as a support vector machine or a random forest, to perform training processing that optimizes a parameter of a classification model that outputs a label predicted based on the independent variable.

Accuracy of training data is important in order to set a classification model obtained by supervised learning as a highly accurate classification model that enables correct classification. For example, it is assumed that there is training data in which a ground truth label “request” is correct for an independent variable “please make operation method easier to understand”, but a ground truth label “guarantee application” is erroneously set. The classification model trained using such erroneous training data is a model having low classification accuracy such that an erroneous predicted label of “guarantee application” is output when, for example, a new independent variable “please make operation instruction easier to understand” is input.

There are roughly two causes for creating such erroneous training data.

The first cause is label noise. The label noise refers to a phenomenon in which an incorrect ground truth label is assigned due to lack of knowledge, misunderstanding, or the like of a label assigner who reads an independent variable of training data and assigns a ground truth label.

The second cause is concept drift. The concept drift refers to a phenomenon in which the correct ground truth label is regarded as an error after a certain time elapses due to changes in a rule (concept) of the ground truth label to be assigned to the independent variable, even when the ground truth label is correct at the time of creating training data. For example, it is assumed that it is correct to initially assign the ground truth label “request” to an independent variable having a value of “please exchange because it is damaged at time of opening”, and such training data is created. Thereafter, it is assumed that a new label “guarantee application” is added, and a new rule is made known to the label assigner that states that the ground truth label “guarantee application” is assigned to an independent variable such as “please exchange because it is damaged at time of opening”. Then, the training data in which the ground truth label “request” is assigned to the independent variable “please exchange because it is damaged at time of opening” before the new rule is made is correct training data based on a rule at that time, but is regarded as an error based on the new rule.

With respect to the problem of label noise, NPL 1 discloses a method of correcting an error by estimating a pair of labels that are likely to be mistaken by a label assigner, and for data obtained by predicting a label different from a ground truth label with a high confidence factor of a classification model among such a pair of labels, replacing the ground truth label with a predicted label. PTL 1 discloses a method of managing reliability of a label of image data and recommending relabeling of data with low reliability.

### CITATION LIST

### Patent Literature

PTL 1: JP 2019-101560A

### Non Patent Literature

NPL 1: C. Northcutt, et. al, “Confident Learning: Estimating Uncertainty in Dataset Labels,” J. Artif. Int. Res., vol. 70, pp. 1373-1411, May 2021.

### SUMMARY OF INVENTION

### Technical Problem

However, in the method disclosed in NPL 1, since presence or absence of label noise is determined using a classification model that trains an old rule based on past training data, there is a problem that a ground truth label assigned based on a new rule after concept drift occurs may be corrected to an incorrect ground truth label based on the old rule. In the method disclosed in PTL 1, since information that cannot be known unless measured at the time of label assignment, such as a work time required for label assignment or whether the person falls asleep during work, is used as reliability of a ground truth label, there is a problem that label noise cannot be detected for existing training data or training data created by a third party.

The invention is made in view of the above problem, and an object of the invention is to provide a training data management system capable of excluding an influence of concept drift in existing training data, selectively detecting only label noise, and correcting a label.

### Solution to Problem

In order to solve the above problem, a training data management system according to the invention includes: a test data management unit configured to manage test data to which a label is to be assigned; a classification model selection unit configured to select a classification model for selecting the label; a classification unit configured to calculate a confidence factor indicating necessity to correct the label selected by the classification model; and a correction candidate calculation unit configured to recommend a correction candidate of the label when the confidence factor exceeds a predetermined value.

### Advantageous Effects of Invention

According to the invention, it is possible to exclude an influence of concept drift in existing training data, selectively detect only label noise, and correct a label.

Additional features related to the invention will become apparent from the description of the present description and the accompanying drawings. Problems, configurations, and effects other than those described above will be apparent according to description of the following embodiment.

### BRIEF DESCRIPTION OF DRAWINGS

FIG. 1 is a diagram illustrating a hardware structure example of a training data management server according to an embodiment of the invention.

FIG. 2 is a diagram illustrating a configuration example of a training data management system according to an embodiment of the invention.

FIG. 3 is a diagram illustrating a configuration example of training data information according to an embodiment of the invention.

FIG. 4 is a diagram illustrating a configuration example of classification model information according to an embodiment of the invention.

FIG. 5 is a diagram illustrating a configuration example of test data information according to an embodiment of the invention.

FIG. 6 is a diagram illustrating a configuration example of classification result information according to an embodiment of the invention.

FIG. 7 is a diagram illustrating a configuration example of event information according to an embodiment of the invention.

FIG. 8 is a diagram illustrating a configuration example of related event information according to an embodiment of the invention.

FIG. 9 is a diagram illustrating a configuration example of correction candidate information according to an embodiment of the invention.

FIG. 10 is a flowchart illustrating processing executed by the training data management server according to an embodiment of the invention.

FIG. 11 is a diagram illustrating a configuration example of a correction recommendation screen according to an embodiment of the invention.

### DESCRIPTION OF EMBODIMENTS

Hereinafter, specific embodiments of the invention will be described with reference to the drawings.

### Hardware Structure

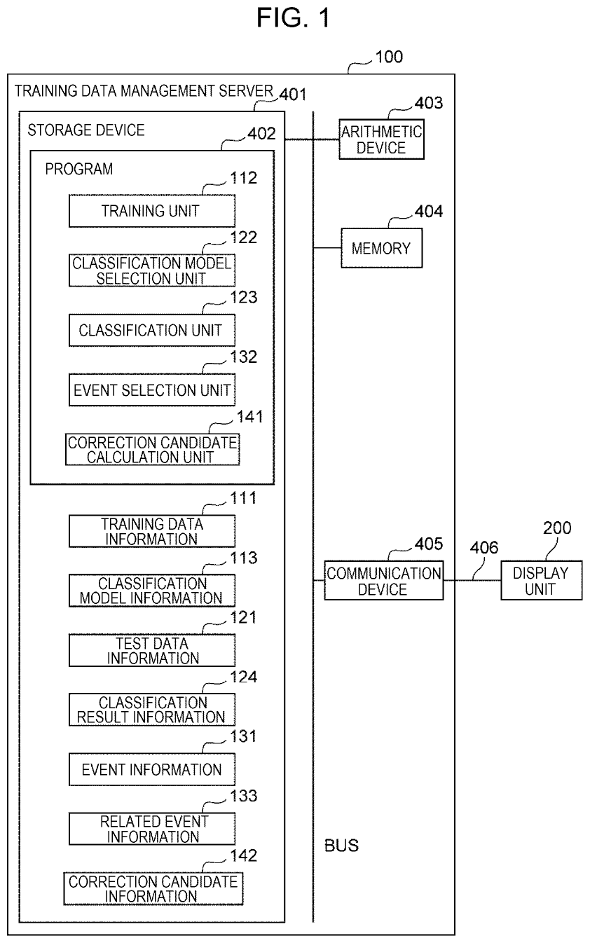

FIG. 1 is a configuration diagram illustrating an example of a hardware structure of a training data management server 100.

As illustrated in FIG. 1, the training data management server 100 includes a storage device 401, a program 402, an arithmetic device 403, and a communication device 405, and each unit is connected to each other via a bus.

The storage device 401 includes a non-volatile storage element such as a solid state drive (SSD) and a hard disk drive. The storage device 401 stores the program 402 that defines an operation of the arithmetic device 403 and various types of information 111, 113, 121, 124, 131, 133, and 142 used or generated by the arithmetic device 403. A memory 404 includes a volatile storage element such as a random access memory (RAM).

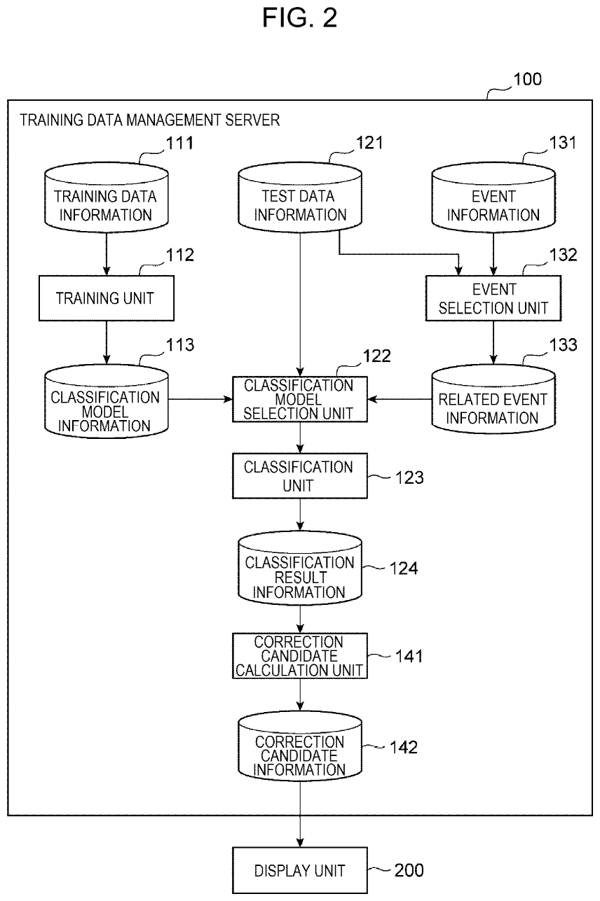

The arithmetic device 403 is implemented by a processor such as a central processing unit (CPU). The arithmetic device 403 reads the program 402 stored in the storage device 401 into the memory 404 and executes the program 402 to implement processing by each functional unit illustrated in FIG. 2. The communication device 405 communicates with an external device such as a display unit 200 via a network 406. Hereinafter, the training data management server 100 is simply referred to as a server 100.

### System Configuration

FIG. 2 is a diagram illustrating a configuration example of a training data management system according to an embodiment of the invention. The training data management system illustrated in FIG. 2 includes the training data management server 100 and the display unit 200. The training data management server 100 is communicably connected to the display unit 200 used by a user of the training data management system.

The training data management server 100 includes, as information stored in a storage unit thereof, training data information 111, classification model information 113, test data information 121, classification result information 124, event information 131, related event information 133, and correction candidate information 142. A training unit 112, a classification model selection unit 122, a classification unit 123, an event selection unit 132, and a correction candidate calculation unit 141 are provided as functional units that perform calculation using these pieces of information.

The server 100 executes processing as described below as a whole. First, the training unit 112 reads the training data information 111, trains a classification model based on a predetermined training method, and saves the classification model obtained as a training result in a file. Then, a path of the saved file and a training period are stored as the classification model information 113. At this time, any known method such as a random forest or a support vector machine may be used as a training method. The training period may be calculated as a range of dates when ground truth labels are assigned to the training data used for training the classification model, or as a list of the dates.

Meanwhile, the event selection unit 132 reads the test data to be determined from the test data information 121, extracts only an event related to the ground truth label assigned to the test data, and stores an ID and an occurrence date of the event in the storage unit as the related event information 133. At this time, the event may be any event having a possibility of being related to an association between the independent variable and the ground truth label based on knowledge of an expert in the field, such as manual update in which a label assignment rule is described, or if the independent variable is text describing information on the product, a change in a vendor for producing a part of a product or new product launch.

In a case where a ground truth label related to the event is not designated in the event information 131, when the same ground truth label is assigned to a plurality of pieces of training data and test data having similar independent variables before and after an occurrence date of the event, it may be calculated that the event is not related to the ground truth label. At this time, similarity of the independent variables can be calculated by a known method such as cosine similarity or K-means clustering. Further, when information on an occurrence time of the event is not stored in the event information 131, the occurrence time may be estimated by detecting a change point of the independent variable.

Then, the classification model selection unit 122 reads the related event information 133, selects the latest event occurrence date in the related event information 133, and selects a classification model including only a date newer than the event occurrence date as a training period from the classification model information 113.

The classification unit 123 classifies the test data to be determined the classification model selected by the classification model selection unit 122, and stores a predicted label and a confidence factor obtained as a classification result in the storage unit as the classification result information 124. At this time, the predicted label is a label output by the classification model. The confidence factor is an index indicating a likelihood of the predicted label, and can be calculated by a known method such as a method disclosed in NPL 1 or in the case of binary classification, a difference between classification probabilities regarding two labels. This means that the higher the confidence factor, the higher necessity to correct the originally assigned ground truth label to the predicted label output by the classification model.

The correction candidate calculation unit 141 reads the classification result information 124, and for the test data having the confidence factor exceeding a predetermined value, stores the independent variable, the ground truth label, the predicted label as a correction candidate, and an assigner name of the ground truth label as the correction candidate information 142 in the storage unit, and instructs the display unit 200 to display the correction candidate information 142. At this time, the correction may be requested from an assigner different from the above assigner.

### Data Structure Example

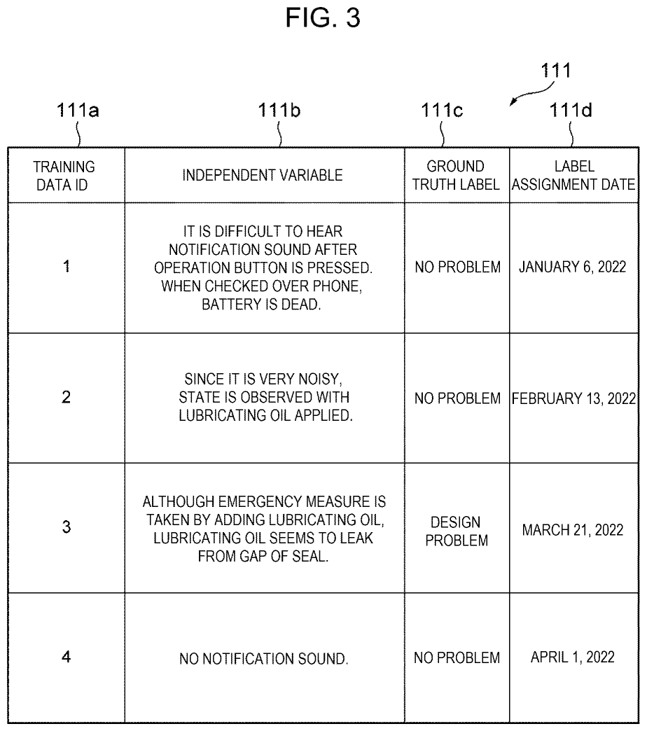

Next, a data structure example of each piece of information stored in the storage device of the server 100 will be described with reference to FIGS. 3 to 9. First, FIG. 3 is a diagram illustrating a data structure example of the training data information 111. The training data information 111 illustrated in FIG. 3 includes fields 111a to 111d. The field 111a stores a training data ID that is identification information for identifying training data. The field 111b stores an independent variable of the training data. The field 111c stores a ground truth label that is a dependent variable assigned to the training data. The field 111d stores a label assignment date on which the ground truth label is assigned to the training data.

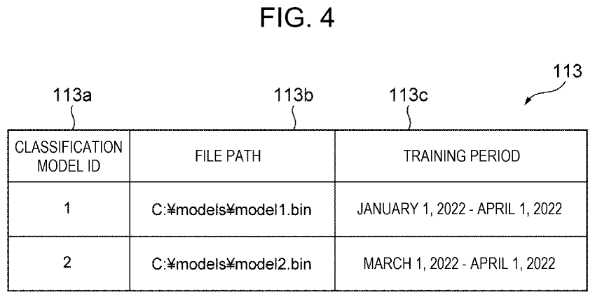

FIG. 4 is a diagram illustrating a data structure example of the classification model information 113. The classification model information 113 illustrated in FIG. 4 includes fields 113a to 113c. The field 113a stores a classification model ID that is identification information for identifying a classification model. The field 113b stores a file path in which the classification model is saved. The field 113c stores a training period indicating a period of data used for training the classification model. The training period may be a range of dates when ground truth labels are assigned to the training data used for training the classification model, or a list of the dates.

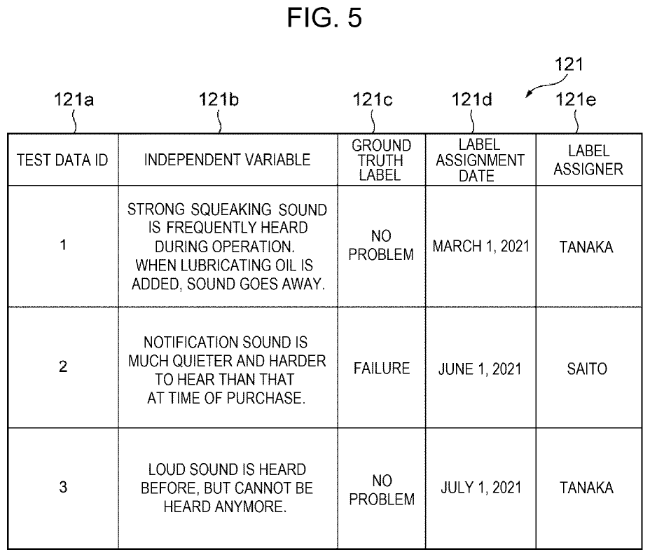

FIG. 5 is a diagram illustrating a data structure example of the test data information 121. The test data information 121 illustrated in FIG. 5 includes fields 121a to 121e. The field 121a stores a test data ID that is identification information for identifying the test data. The field 121b stores an independent variable of the test data. The field 121c stores a ground truth label that is a dependent variable assigned to the test data. The field 121d stores a label assignment date on which the ground truth label is assigned to the test data. The field 121e stores a label assigner, which is identification information for identifying a person in charge who assigns the ground truth label to the test data.

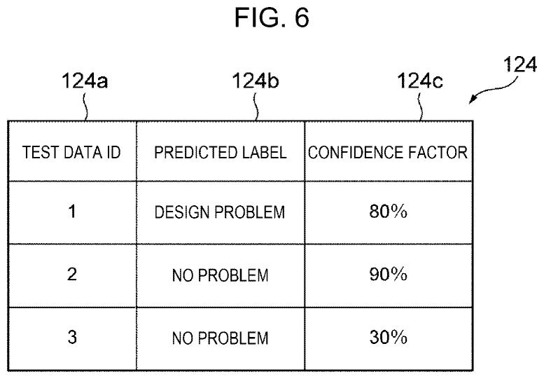

FIG. 6 is a diagram illustrating a data structure example of the classification result information 124. The classification result information 124 illustrated in FIG. 6 includes fields 124a to 124c. The field 124a stores a test data ID that is identification information for identifying the test data. The field 124b stores a predicted label that is a value of the dependent variable predicted by the classification model for the test data. The field 124c stores a value of a confidence factor calculated based on an output of the classification model for the test data.

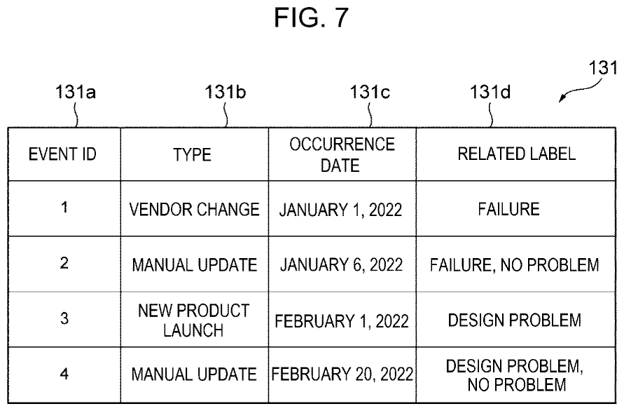

FIG. 7 illustrates a data structure example of the event information 131. The event information 131 illustrated in FIG. 7 includes fields 131a to 131d. The field 131a stores an event ID that is identification information for identifying an event. The field 131b stores a type of the event. The field 131c stores an occurrence date of the event. The field 131d stores a related label indicating a dependent variable related to the event.

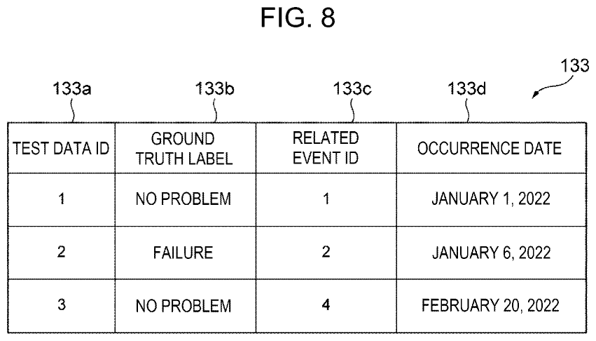

FIG. 8 is a diagram illustrating a data structure example of the related event information 133. The related event information 133 illustrated in FIG. 8 includes fields 133a to 133d. The field 133a stores a test data ID that is identification information for identifying the test data. The field 133b stores a ground truth label of the test data. The field 133c stores a related event ID that is identification information for identifying an event related to the ground truth label of the test data. The field 133d stores an occurrence date of the related event.

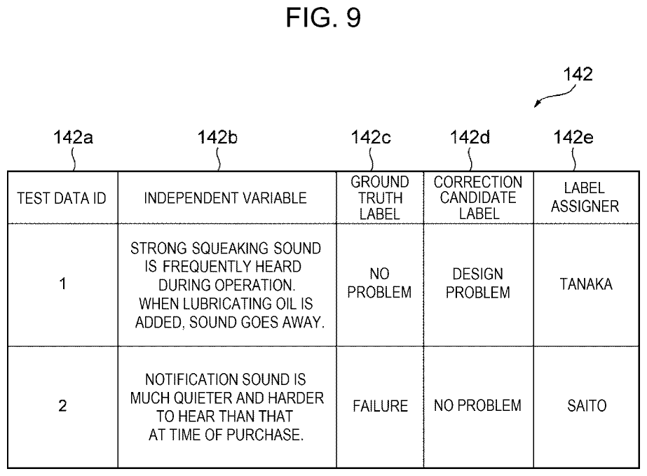

FIG. 9 is a diagram illustrating a data structure example of the correction candidate information 142. The correction candidate information 142 illustrated in FIG. 9 includes fields 142a to 142e. The field 142a stores a test data ID that is identification information for identifying test data of a correction candidate. The field 142b stores an independent variable of the test data. The field 142c stores a ground truth label assigned to the test data. The field 142d stores a correction candidate label to be a correction destination for the ground truth label of the test data. The field 142e stores identification information for identifying a label assigner who assigns the ground truth label to the test data.

### Flowchart Example

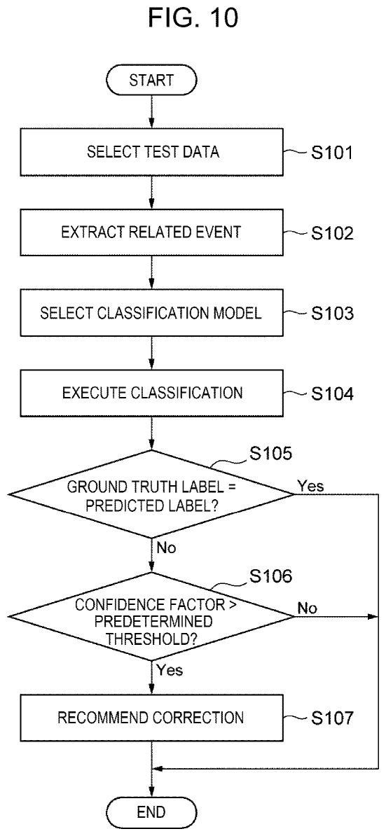

FIG. 10 is a flowchart illustrating an example of an operation of the server 100.

First, the event selection unit 132 of the server 100 reads test data to be determined from the test data information 121 (step S101). Next, the event selection unit 132 extracts only an event related to a ground truth label assigned to the test data, and stores an ID and an occurrence date of the event as the related event information 133 (step S102). At this time, the event may be designated as any event having a possibility of being related to an association between the independent variable and the ground truth label based on knowledge of an expert in the field, such as manual update in which a label assignment rule is described, or if the independent variable is text describing information on the product, a change in a vendor for producing a part of a product or new product launch. In a case where the ground truth label related to the event is not designated in the event information 131, when the same ground truth label is assigned to a plurality of pieces of training data and test data having similar independent variables before and after the occurrence date of the event, it may be calculated that the event is not related to the ground truth label. At this time, similarity of the independent variables can be calculated by a known method such as cosine similarity or K-means clustering. Further, when information on an occurrence time of the event is not stored in the event information 131, the occurrence time may be estimated by detecting a change point of the independent variable.

Subsequently, the classification model selection unit 122 reads the related event information 133, extracts the latest event occurrence date in the related event information 133, and selects a classification model including only a date newer than the event occurrence date as a training period from the classification model information 113 (step S103).

Subsequently, the classification unit 123 classifies the test data to be determined using the classification model selected by the classification model selection unit 122, and stores the predicted label and a confidence factor obtained as a classification result as the classification result information 124 (step S104). This predicted label is a label output by the classification model. The confidence factor is an index indicating a likelihood of the predicted label, and can be calculated by a known method such as a method disclosed in NPL 1 or in the case of binary classification, a difference between classification probabilities regarding two labels.

Subsequently, the correction candidate calculation unit 141 reads the classification result information 124, determines whether the already assigned ground truth label matches the predicted label, and ends the processing if the ground truth label matches the predicted label (step S105). If the ground truth label and the predicted label do not match, it is determined whether the confidence factor exceeds a predetermined value, and if the confidence factor does not exceed the predetermined value, the processing ends (step S106). If the confidence factor exceeds the predetermined value, the independent variable, the ground truth label, the predicted label as a correction candidate, and an assigner name of the ground truth label for the test data are stored as the correction candidate information 142, and the display unit 200 is instructed to display the correction candidate information 142, that is, correction is recommended (step S107). At this time, the correction may be recommended to an assigner different from the assigner described in the label assigner name.

### Screen Example

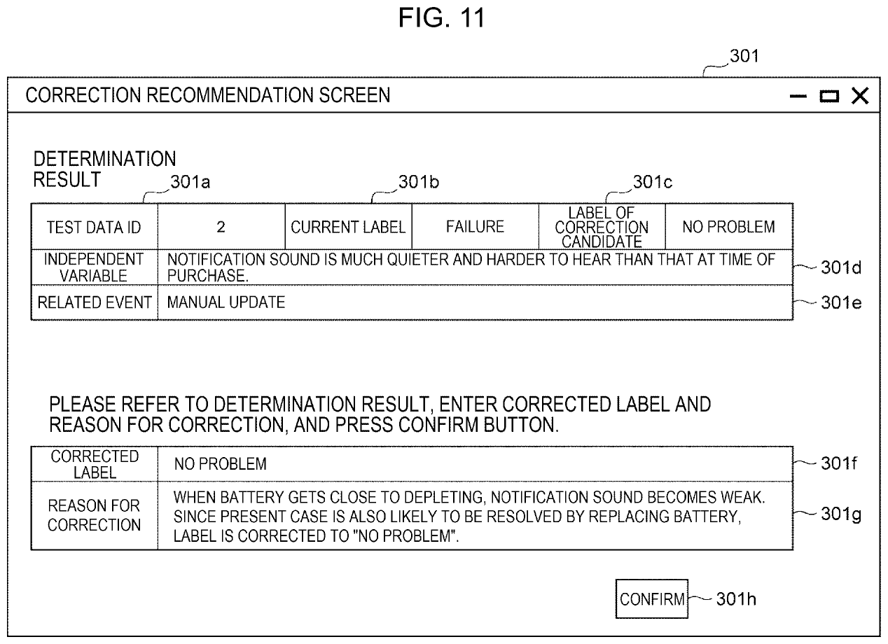

FIG. 11 illustrates an example of a correction recommendation screen 301 displayed in step S107 in FIG. 10. These correction recommendation screens 301 may be displayed and output on the display unit 200 in a personal computer, for example.

The correction recommendation screen 301 illustrated in FIG. 11 may be an example of a case where, when correction to the ground truth label assigned to the test data is recommended, a current ground truth label and a label of the correction candidate are designated and recommended together with the independent variable of the test data to be corrected. The correction recommendation screen 301 illustrated in FIG. 11 may include fields 301a to 301h. The field 301a may display identification information of the test data to be corrected as a “test data ID”. The field 301b may display a ground truth label assigned to the test data to be corrected as a “current label”. The field 301c may display a “label of correction candidate” as a candidate for a correction destination of the “current label” in the field 301b. The field 301d may display the independent variable of the test data to be corrected as an “independent variable”. The field 301e may display an event related to the ground truth label assigned to the test data to be corrected as a “related event”. The field 301f may receive text input of a label selected by a user of the training data management system according to the invention, with reference to a candidate label defined by the “label of correction candidate”, and display the text input as “corrected label”. The field 301g may receive an input of a text describing a reason why the user selects the “corrected label” and display the reason as “reason for correction”. The user may be able to select the correction of the label assigned to the test data to be corrected for the information displayed on the correction recommendation screen 301. For example, the user may move a pointer of the personal computer to an operation field displayed as “confirm” in the field 301h in FIG. 11, and click the pointer on the personal computer to adopt and confirm information displayed in the “corrected label” and the “reason for correction”.

According to the embodiment of the invention described above, the following effects are obtained.
(1) A training data management system according to the invention includes: a test data management unit configured to manage test data to which a label is to be assigned; a classification model selection unit configured to select a classification model for selecting the label; a classification unit configured to calculate a confidence factor indicating necessity to correct the label selected by the classification model; and a correction candidate calculation unit configured to recommend a correction candidate of the label when the confidence factor exceeds a predetermined value.

With the above configuration, it is possible to exclude an influence of the concept drift in existing training data, selectively detect only label noise, and correct a label.
(2) An event information management unit configured to manage information related to an event that causes the test data to be generated is further included, and the classification model selection unit selects the classification model based on an occurrence date and time of the event. Since the concept drift is mostly caused by occurrence of any event, an influence of the concept drift can be more appropriately excluded by this configuration.
(3) The event information management unit manages, for each type of event, a type of label that affects the event, and the classification model selection unit selects a classification model that is retrained with training data after occurrence of an influential event. Accordingly, since the determination is performed using the retrained classification model for the event that occurs and a related label, it is possible to perform the determination with higher accuracy.
(4) An event selection unit configured to, when the same label is assigned to a plurality of pieces of test data before and after an occurrence time of a certain event, determine that a type of the event does not affect the label and exclude the event from a feedback target is further included. Accordingly, it is possible to reduce a calculation resource.
(5) The event selection unit estimates an occurrence time of the event based on a change point of a feature. Accordingly, even when the occurrence time of the event is not recorded in event information in advance, it is possible to select a classification unit based on the estimated occurrence time of the event.
(6) The correction candidate calculation unit recommends a correction to a person different from a label assigner who assigns a label. Accordingly, objective evaluation by an operator who initially assigned the label becomes possible, and improvement in accuracy of correction can be expected.

The technical scope of the invention is not limited to the scope described in the above embodiment, and various modifications are included without departing from the main features of the invention. Therefore, the embodiments described above are merely examples and are not to be construed as limiting. In addition, a part of the configuration of each embodiment can be added, deleted, or replaced with another configuration, and all are within the scope of the invention.

### Reference Signs List

100: training data management server (training data management system)
112: training unit
122: classification model selection unit
123: classification unit
132: event selection unit
141: correction candidate calculation unit

1. A training data management system comprising:
a test data management unit configured to manage test data to which a label is to be assigned;
a classification model selection unit configured to select a classification model for selecting the label;
a classification unit configured to calculate a confidence factor indicating necessity to correct the label selected by the classification model; and
a correction candidate calculation unit configured to recommend a correction candidate of the label when the confidence factor exceeds a predetermined value.

2. The training data management system according to claim 1, further comprising:
an event information management unit configured to manage information related to an event that causes the test data to be generated, wherein
the classification model selection unit selects the classification model based on an occurrence date and time of the event.

3. The training data management system according to claim 2, wherein
the event information management unit manages, for each type of the event, a type of label that affects the event, and
the classification model selection unit selects a classification model that is retrained with training data after occurrence of an influential event.

4. The training data management system according to claim 2, further comprising:
an event selection unit configured to, when the same label is assigned to a plurality of pieces of test data before and after an occurrence time of a certain event, determine that a type of the event does not affect the label and exclude the event from a feedback target.

5. The training data management system according to claim 4, wherein
the event selection unit estimates an occurrence time of the event based on a change point of a feature.

6. The training data management system according to claim 1, wherein
the correction candidate calculation unit recommends a correction to a person different from a label assigner who assigns the label.
